(19) United States
(12) Patent Application Publication
(10) Pub. No.: US 2024/0388249 A1
(43) Pub. Date: Nov. 21, 2024

(54) SOLAR SYSTEM

(71) Applicant: TOTALENERGIES SE, Courbevoic (FR)

(72) Inventors: Pierre-Emmanuel HICKEL, Colombes (FR); Théodoric BOUCHEZ, Marcq-en-Baroeul (FR)

(73) Assignee: TOTALENERGIES SE, Courbevoic (FR)

(21) Appl. No.: 18/578,566

(22) PCT Filed: Jul. 6, 2022
(86) PCT No.: PCT/EP2022/068692

§ 371 Date: Jan. 11, 2024

(30) Foreign Application Priority Data
Jul. 15, 2021 (FR) 2107662

(51) Int. Cl. H02S 40/44; A01G 13/02; A01G 13/08; F24H 3/04; F24S 10/00; F24S 60/30; H02J 7/35; H02S 10/20; H02S 10/40; H02S 20/32

(52) U.S. Cl. CPC H02S 40/44; A01G 13/0206; A01G 13/08; F24S 10/00; F24S 60/30; H02S 10/20; H02S 10/40; H02S 20/32; F24H 3/0405; H02J 7/35

(57) ABSTRACT

The present invention relates to a solar system (1) comprising:
a solar shade (3) configured to be arranged in a crop area (5), said solar shade (3) comprising at least one solar panel (7) designed to generate energy,
a storage unit (9a, 9b) for the energy generated by the solar panel (7).

The present invention relates to a solar system and more particularly to a solar system intended to be installed in a crop area, for example a field.

Photovoltaic farms comprising a large quantity of photovoltaic panels configured to supply a power grid are highly developed, in particular in rural or desert areas. However, such photovoltaic farms tend to compete with the other uses of the soil, in particular crops, and the transmission of the electrical energy generated in these farms to residential areas can be difficult and leads to significant losses.

In addition, rural areas and in particular agricultural farms may have important energy needs, in particular for powering agricultural equipment, local industries (food industry, etc.), local communities or local electrical charging stations. With climate change, it has also become crucial to protect crops from weather-related costs such as cold or strong heat in order to avoid significant production losses in the event of difficult weather conditions.

In order to at least partially overcome these disadvantages, the present invention aims to allow the installation of solar panels in agricultural areas without removing the crops and to limit the transmission of the energy generated by the solar panels.

To this end, the invention relates to a solar system comprising:
a solar shade configured to be arranged in a crop area, said solar shade comprising at least one solar panel configured to generate energy,
a storage unit for the energy generated by the solar panel.

The use of a solar shade in a crop area makes it possible to generate energy while at least partially preserving the crop area. In addition, the use of a storage unit associated with the solar shade makes it possible to use the energy generated at the desired times and thus expand the possible uses of the generated energy.

According to another aspect of the present invention, the solar panel is a hybrid solar panel configured to produce thermal energy and electrical energy and wherein said solar system also comprises a fluidic circuit in fluid connection with the hybrid solar panel.

The use of a hybrid solar panel makes it possible both to produce thermal energy that can in particular be used to force crops, and electrical energy that can supply, for example, agricultural equipment.

According to another aspect of the present invention, the solar system also comprises a thermal circuit configured to provide thermal regulation to the crop area.

According to another aspect of the present invention, the thermal circuit is a hydraulic thermal circuit in fluid contact with the fluid circuit to allow a fluid to pass from the fluid circuit to the hydraulic thermal circuit.

According to another aspect of the present invention, the storage unit is a tank arranged at the interface between the fluid circuit and the hydraulic thermal circuit.

According to another aspect of the present invention, the tank is an underground tank.

According to another aspect of the present invention, the solar system also comprises a heat exchanger in the hydraulic thermal circuit or the fluid circuit. The heat exchanger makes it possible to use different fluids in the fluid circuit and the hydraulic thermal circuit.

According to another aspect of the present invention, the solar panel generates electrical energy and the thermal circuit is an electrical thermal circuit configured to provide thermal regulation to the crop area from the electrical energy stored in the storage unit.

According to another aspect of the present invention, the electrical thermal circuit comprises at least one of the following equipment:
heating resistors or electric convectors arranged in the crop area,
a regulated air circulation device.
heating elements configured to blow air onto the crops.

According to another aspect of the present invention, the storage unit comprises at least one of the following means:
electrochemical storage means such as a battery,
thermochemical storage means,
gas compression means,
thermal storage hubs,
thermomechanical storage means.

According to another aspect of the present invention, the solar system also comprises a device for drying agricultural stocks and said drying device is powered from the electrical energy stored in the storage unit.

According to another aspect of the present invention, the solar system also comprises a charging station for agricultural equipment, wherein the charging station is powered from the electrical energy stored in the storage unit.

According to another aspect of the present invention, the solar system comprises electrical equipment intended to be arranged in an agricultural building and said electrical equipment is powered from the electrical energy stored in the storage unit.

According to another aspect of the present invention, the solar shade comprises a mobile element and an electric motor configured to move said mobile element and said electric motor is powered from the electrical energy stored in the storage unit.

According to another aspect of the present invention, the mobile element makes it possible to modify the orientation of the solar panel as well as a shadow projected from the solar shade on the crop area.

Other features and advantages of the invention will become more clearly apparent on reading the following description, given by way of illustrative and non-limiting example, and of the appended drawings, in which:

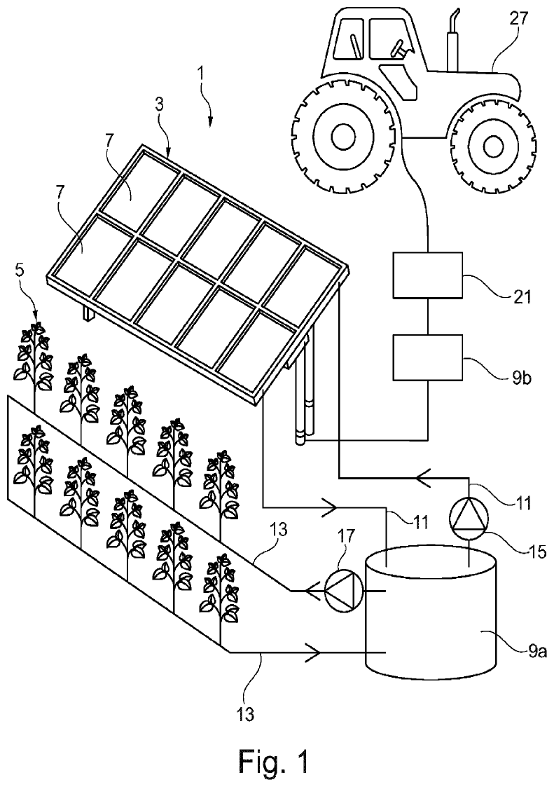

FIG. 1 shows a schematic perspective view of a solar system according to a first embodiment of the present invention;

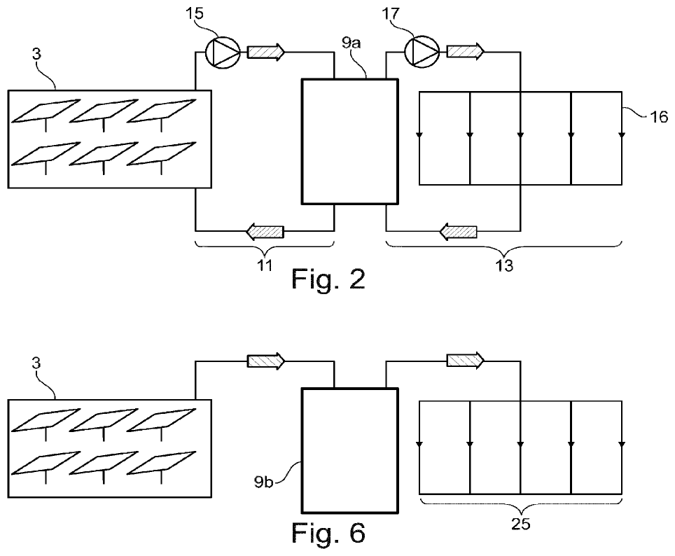

FIG. 2 shows a diagram of a fluid circuit and a thermal circuit;

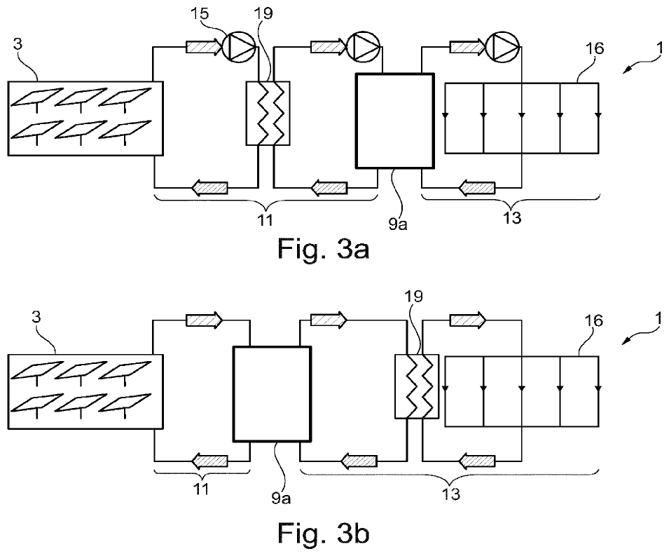

FIG. 3a shows a diagram of a fluid circuit comprising a heat exchanger and a thermal circuit;

FIG. 3b represents a diagram of a thermal fluid circuit and a thermal circuit comprising an exchanger;

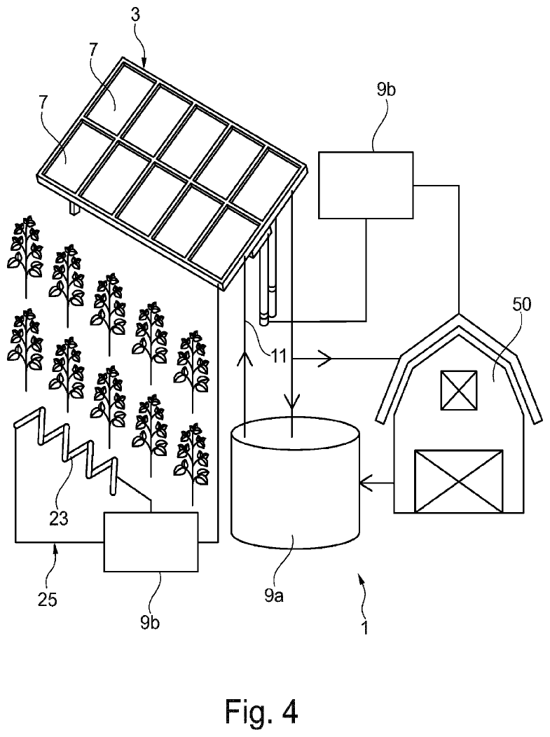

FIG. 4 shows a schematic perspective view of a solar system according to a second embodiment of the present invention;

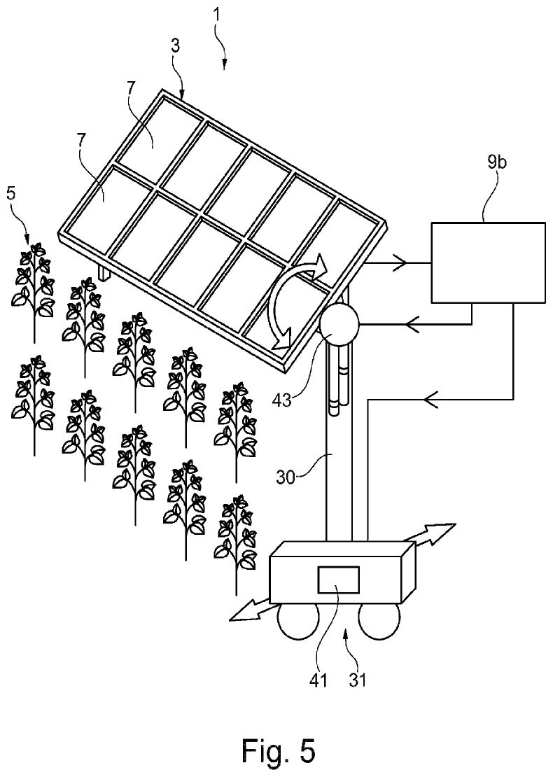

FIG. 5 shows a schematic perspective view of a solar system according to a third embodiment of the present invention;

FIG. 6 shows a diagram of a photovoltaic circuit and a thermal circuit.

In these figures, identical elements bear the same references.

The following embodiments are examples. Although the description refers to one or more embodiments, this does not necessarily mean that each reference relates to the same embodiment, or that the features apply only to a single embodiment. Simple features of different embodiments may also be combined or interchanged to provide other embodiments.

FIG. 1 shows a first embodiment of a solar system 1 according to the present invention.

The solar system 1 comprises at least one solar shade 3 configured to be arranged in a crop area 5. The solar shade 3 is for example arranged above the crop area 5. Alternatively, the crop area 5 may comprise alternating rows of crops and rows of solar shades 3.

The solar shade 3 comprises at least one solar panel 7. In the case of FIG. 1, the solar shade 3 comprises ten solar panels 7, but a different number of solar panels 7 may of course be arranged on the solar shade 3. The solar panels 7 may be configured to produce electrical energy (photovoltaic panels) or may be configured to produce thermal energy by warming a heat transfer fluid, for example water. The solar panels 7 may also be hybrid solar panels configured to produce both electrical energy and thermal energy.

The solar system 1 also comprises at least one storage unit 9a, 9b for the energy generated by the solar panels 7. The solar system 1 may comprise a plurality of storage units 9a, 9b for the generated energy and in particular a first storage unit 9a configured to store the thermal energy generated by the solar panels 7 and a second storage unit 9b configured to store the electrical energy generated by the solar panels 7.

Different technologies can therefore be used for the storage unit 9a, 9b, whether for the storage of thermal energy or electrical energy. The various technologies in particular comprise electrochemical storage means such as a battery, thermochemical storage means, gas compression means, thermal storage hubs, thermomechanical storage means.

In addition, the type of storage unit 9a, 9b selected also depends on the duration of the storage considered, in particular for thermal storage. Indeed, different storage periods can be defined as a function of requirements. For example, so-called seasonal storage for which heat is stored during a first season, for example a hot season (summer), then restored in a second season, for example a cold season (winter). Such seasonal storage can be done via underground storage, for example by aquifer in which at least two wells connecting a deep aquifer (for example between 1000 and 2000 m) are provided. One or more wells are used for the extraction of water, the other well(s) are used for the reinjection of water, such that the aquifer is constantly in the state of hydraulic equilibrium. In this case, it is the water itself which ensures the storage of the heat. The underground storage can also be done via geothermal probes arranged at a depth of between 50 and 300 m. A heat pump can be used to extract heat from the geothermal probes. The storage can also be carried out in the form of geothermal wells. Phase-change materials or thermochemical reactions employing hydrated salts can also be used, in particular for seasonal storage.

For other applications, daily storage can be used with heat storage during the day and reproduction during the night; for these applications, a water tank, or phase-change materials such as paraffin can be used.

The techniques mentioned above are generally used for heat-transfer fluid temperatures below 100° C. For temperatures above 100° C., it is also possible to use storage by oil bath or solid-route storage, for example storage on rocks, concretes or ceramics.

As shown in FIG. 1, the first storage unit 9a can be a tank of heat transfer fluid, for example a water or oil tank (in particular if the temperature is greater than 100° C.) which is for example buried. The tank 9a of FIG. 1 can therefore be replaced by one of the storage technologies cited above. It is also possible to combine different storage technologies which are then distributed in a plurality of storage units 9a. In the case of FIG. 1, the second storage unit 9b is a battery or a set of batteries making it possible to store the electrical energy generated by the solar panels 7.

The solar system 1 may also comprise a fluid circuit 11 in fluid connection with the solar panels 7. The fluid circuit 11 makes it possible to circulate the heat transfer fluid, for example water, behind the solar panels 7 and to allow at least a part of the heat generated by the solar panels 7 to be recovered. The fluid circuit 11 may comprise a reservoir 9a in which the heated heat-transfer fluid is stored after it passes behind the solar panels 7 as shown in FIGS. 1 and 2. The fluid circuit 11 thus forms a loop for circulation of a heat transfer fluid between the tank 9a and the solar panels 7. The heat transfer fluid is for example circulated via a pump 15 in the fluidic circuit 11. The pump 15 is for example controlled by a processing unit of the solar system 1 configured to actuate the pump 15 when the heat-transfer fluid has to be circulated in the fluid circuit 11. The circulation can be permanent or only at certain predetermined times or certain predetermined seasons for example during the day and stopped at night or during the summer and stopped in the winter. The activation of the pump 15 and therefore the circulation can also be determined as a function of an outside temperature, for example a temperature measured at the solar panels 7 and/or a measured temperature of the heat transfer fluid in the tank 9a. The solar system 1 may also comprise a thermal circuit configured to provide thermal regulation to the crop area 5. In the case of FIGS. 1 and 2, the thermal circuit is a hydraulic thermal circuit 13 in fluid contact with the fluid circuit 11, for example via the reservoir 9a. Thus, the fluid circuit 11 makes it possible to heat the heat transfer fluid inside the tank 9a and the hydraulic thermal circuit 13 makes it possible to circulate the heat transfer fluid heated in the crop area 5 to allow for example the forcing of the crops or to prevent the crops from freezing. The hydraulic thermal circuit 13 is for example formed by tubes 16 arranged at the foot of the crops or buried near the crops. The hydraulic thermal circuit 13 comprises for example a pump 17 independent of the pump 15 of the fluid circuit 11 to circulate the heat transfer fluid between the tank 9a and the crop area 5. The pump 17 is for example controlled by a processing unit of the solar system 1 configured to actuate the pump 17 when the heat-transfer fluid has to be circulated in the hydraulic thermal circuit 13. The circulation can be permanent or only at certain predetermined times or certain predetermined seasons, for example during the night or the winter and stopped in the day or the summer. The activation of the pump 17 and therefore the circulation of the heat transfer fluid in the hydraulic thermal circuit 13 can also be done as a function of measured temperatures, for example an outside temperature measured at the crops and/or a measured temperature of the heat transfer fluid in the tank 9a.

According to a first particular embodiment shown in FIG. 3a, a heat exchanger 19 is arranged in the fluid circuit 11 so that the heat transfer fluid circulating behind the solar panels 7 can be different from the heat transfer fluid circulating in the storage unit 9a. The various heat transfer fluids can be water, an aqueous solution, oil, or air.

According to a second particular embodiment shown in FIG. 3b, a heat exchanger 19 is arranged in the hydraulic thermal circuit 13 so that the heat transfer fluid circulating in the storage unit 9a can be different from the heat transfer fluid circulating in the crop area 5. The various heat transfer fluids can be water, an aqueous solution, oil, or air.

In the example of FIG. 1, the solar panels are hybrid 7, photovoltaic and heat-transfer solar panels, but the solar panels 7 can also be purely thermal solar panels 7 as in FIG. 2. In this case, the solar system 1 only comprises the first storage unit 9a (and not the second storage unit 9b, nor the equipment associated with the second storage unit 9b). Alternatively, the solar panels can also be purely photovoltaic and associated with a second storage unit 9b as shown in FIG. 6 (in this case, there is no first storage unit 9a, nor equipment associated with the first storage unit 9a, or alternatively a first storage unit 9a in which the stored heat is obtained by converting the electrical energy generated by the photovoltaic panels 7 is stored in the first storage unit 9a which can replace the storage unit 9b or supplement the storage unit 9b). An electrical thermal circuit 25 comprising for example heating resistors arranged at the crops and supplied via the storage unit 9b can be used.

In the example of FIG. 1, the second storage unit 9b makes it possible to store the electrical energy generated by the solar panels 7. The second storage unit 9b is for example made by one or more batteries. The solar system 1 may also comprise a charging station 21 for agricultural equipment 27. The charging station 21 is powered from the electrical energy stored in the storage unit 9b or directly by the solar panels 7. The second storage unit 9b can also be used for other applications and in particular for the thermal circuit 13 used to force crops instead of or in addition to a hydraulic thermal circuit as shown in FIGS. 4 and 6. In this case, the thermal circuit is an electrical thermal circuit 25 comprising heating elements arranged in the crop area 5 such as heating resistors 23, electric convectors, a regulated air circulation device or heating elements configured to blow air onto the crops or to heat a fluid intended to be stored or to circulate in the crops.

Several second storage units 9b can be used for different applications. For example, in FIG. 4, a second storage unit 9b is used to supply electrical equipment of an agricultural building 50 such as for example lighting or heating the agricultural building 50. The fluid circuit 11 can then be used for the thermal regulation of an agricultural building as shown in FIG. 4. A hydraulic thermal circuit 13 associated with the fluid circuit 11 can also be used for the thermal regulation of the crops in combination with the electrical thermal circuit 25.

According to one embodiment not shown, the solar system 1 comprises a device for drying agricultural stocks powered from a second storage unit 9b. The second storage unit 9b can thus be used to power the various electrical devices of agricultural operation, for example an electric pump of an irrigation or watering circuit.

According to one embodiment shown in FIG. 5, the solar shade 3 comprises a mobile element. In the present case, the solar shade 3 comprises posts 30 configured to be moved, the solar shade 3 is for example arranged on a rolling device 31 and a first electric motor 41 is configured to drive the rolling device 31 and allow the movement of the solar shade 3. In addition, the solar panels 7 can be mounted pivoting on the posts 30 and a second electric motor 43 can be configured to allow the inclination of the solar panels 7 to be adjusted. The inclination of the solar panels 7 can for example be controlled during the day as a function of the incident angle of the solar rays in order to obtain an optimal efficiency of the solar panels 7. Alternatively, the solar panels 7 can have a fixed inclination or the posts 30 can be fixed relative to the floor. The first 41 and second 43 electric motors are then powered from the electrical energy stored in the second storage unit 9b. Such a motorized solar shade 3 makes it possible to control the shadow cast on the crop area 5 adjacent to the solar shade 3 and thus minimize or maximize this shadow as a function of the season and/or temperature for example.

In the examples of FIGS. 1 and 4, the solar panels are hybrid solar panels 7, but the solar panels 7 can also be purely photovoltaic panels 7 as in FIG. 5. Alternatively, the solar panels 7 can also be purely thermal solar panels 7 with a fluidic circuit 11 and a hydraulic thermal circuit 13 to make it possible to regulate the temperature of the crops, or even to regulate the temperature of an agricultural building.

As indicated above, the different features of the different embodiments can be combined or rearranged to provide new configurations of the solar system 1 depending on the needs of the farm. Thus, the size and number of the solar panels 7 and storage units 9a, 9b can be adjusted to obtain the desired energy production.

Thus, the use of a solar system 1 comprising a solar shade 3 arranged in a crop area 5 and associated with a storage unit 9a, 9b for the energy generated by the solar shade 3 makes it possible to install the solar system 1 without removing the crop area 5 and makes it possible via a thermal circuit supplied by the storage unit 9a, 9b to provide thermal regulation of the crops, in particular to allow them to be forced or to keep them from freezing. The solar shade 3 also limits drying during high heat by providing shade to crops, and thermal control can be used to limit the heating of the crops by circulating a heat transfer fluid at a temperature below the outdoor temperature, for example via the use of a buried tank.

In addition, the use of solar panels 7 also makes it possible to provide an electrical source that can be used by the solar shade 3 itself or by agricultural equipment located near the solar shade 3, which makes it possible to limit the distance between the solar panels 7 and the location where the electrical energy generated is used. Such a system makes it possible to obtain an electrical source in a crop area 5 that can be located in a rural area that is off the power grid, and thus to provide energy autonomy to agricultural operation since electrical equipment can be supplied by the energy generated by the solar shade 3 and stored in the storage unit(s) 9b.

1. A solar system (1) comprising:
a solar shade (3) configured to be arranged in a crop area (5), said solar shade (3) comprising at least one solar panel (7) designed to generate energy,
a storage unit (9a, 9b) for the energy generated by the solar panel (7).

2. The solar system (1) according to claim 1 wherein the solar panel (7) is a hybrid solar panel configured to produce thermal energy and electrical energy and wherein said solar system (1) also comprises a fluidic circuit (11) in fluid connection with the hybrid solar panel (7).

3. The solar system (1) according to claim 1 or 2, further comprising a thermal circuit (13, 25) configured to provide thermal regulation to the crop area (5).

4. The solar system (1) according to claim 3, wherein the thermal circuit (13, 25) is a hydraulic thermal circuit (13) in fluid contact with the fluidic circuit (11) to allow a passage of a fluid from the fluidic circuit (11) to the hydraulic thermal circuit (13).

5. The solar system (1) according to claim 4, wherein the storage unit (9a, 9b) is a reservoir (9a) arranged at the interface between the fluid circuit (11) and the hydraulic thermal circuit (13).

6. The solar system (1) according to claim 5, wherein the reservoir (9a) is an underground tank.

7. The solar system (1) according to one of claims 3 to 6, further comprising a heat exchanger (16) in the hydraulic thermal circuit (13) or the fluidic circuit (11).

8. The solar system (1) according to one of claims 3 to 7, wherein the solar panel (7) generates electrical energy and wherein the thermal circuit (13, 25) is an electrical thermal circuit (25) configured to provide thermal regulation to the crop area (5) from the electrical energy stored in the storage unit (9b).

9. The solar system (1) according to the preceding claim wherein the electrical thermal circuit (25) comprises at least one of the following equipment:
heating resistors (23) or electric convectors arranged in the crop area (5),
a regulated air circulation device,
heating elements configured to blow air onto the crops.

10. The solar system (1) according to one of the preceding claims, wherein the storage unit (9a, 9b) comprises at least one of the following means:
electrochemical storage means such as a battery,
thermochemical storage means,
gas compression means,
thermal storage hubs,
thermomechanical storage means.

11. The solar system (1) according to one of the preceding claims, further comprising a device for drying agricultural stocks and wherein said drying device is powered from the electrical energy stored in the storage unit (9a, 9b).

12. The solar system (1) according to one of the preceding claims, further comprising a charging station (21) for agricultural equipment (27) and wherein the charging station (21) is powered from the electrical energy stored in the storage unit (9b).

13. The solar system (1) according to one of the preceding claims, comprising electrical equipment intended to be arranged in an agricultural building (50) and wherein said electrical equipment is powered from the electrical energy stored in the storage unit (9b).

14. The solar system (1) according to one of the preceding claims, wherein the solar shade (3) comprises a mobile element and an electric motor (41, 43) configured to move said mobile element and wherein said electric motor (41, 43) is powered from the electrical energy stored in the storage unit (9b).

15. The solar system (1) according to the preceding claim, wherein the mobile element makes it possible to modify the orientation of the solar panel as well as a shadow projected from the solar shade (3) on the crop area (5).
